(19) United States
(12) Patent Application Publication
(10) Pub. No.: US 2026/0204755 A1
(43) Pub. Date: Jul. 16, 2026

(54) Cell-Connection Aluminum Busbar Structure Integrated with Fuse, and Battery Pack

(71) Applicant: Guangdong Mingji Hi-Tech Electronics Co., Ltd., Dongguan (CN)

(72) Inventors: Hongzhuo ZHANG, Dongguan (CN); Chengfu WANG, Dongguan (CN); Kai ZHENG, Dongguan (CN)

(21) Appl. No.: 19/171,811

(22) Filed: Apr. 7, 2025

(30) Foreign Application Priority Data
Jan. 10, 2025 (CN) 202510043549.7

(51) Int. Cl. H01M 50/583; H01M 50/503; H01M 50/519; H01M 50/522; H01M 50/588

(52) U.S. Cl. CPC H01M 50/583; H01M 50/503; H01M 50/519; H01M 50/522; H01M 50/588

(57) ABSTRACT

Disclosed are a cell-connection aluminum busbar structure integrated with a fuse and a battery pack. The cell-connection aluminum busbar structure integrated with a fuse includes a fuse portion, a first conductor portion connected to one end of the fuse portion, a second conductor portion connected to the other end of the fuse portion, a transmission portion connected to the top of the first conductor portion, an insulating portion connected to the bottom of the first conductor portion, and an aluminum busbar connected to the second conductor portion. The invention has the following beneficial effects: 1, the cell-connection aluminum busbar structure has the function of a fuse and is low in manufacturing cost; 2, the structure is designed to be light and thin.

### CROSS-REFERENCE TO RELATED APPLICATIONS

The present application claims priority to Chinese Patent Application No. 202510043549.7, filed on Jan. 10, 2025, the entire disclosure of which is incorporated herein by reference.

### TECHNICAL FIELD

The application relates to the technical field of electronics, in particular to a cell-connection aluminum busbar structure integrated with a fuse, and a battery pack.

### BACKGROUND

At present, with the rapid development of new energy vehicles, power batteries are inevitably used in the new energy vehicles, and the safety of the power batteries becomes an important task. Existing cells contact systems (CCSs) adopt a flexible printed circuit (FPC) to acquire and transmit electric signals such as voltage signals, current signals and temperature signals, and a fuse is integrated on the FPC because it is easy to implement the function of the fuse on the FPC. However, the cost of the FPC is relatively high.

When a low-cost flexible flat cable (FFC) or wiring harness is used to acquire and transmit electric signals, integration of the fuse will not be available, leading to the lack of the function of the fuse of a whole CCS. In this case, the safety of heat management of a battery pack cannot be guaranteed, and a circuit will not be cut off timely in case of a current abnormality.

In view of this, it is urgently needed to develop a cell-connection aluminum busbar structure integrated with a fuse, and a battery pack.

### SUMMARY

The application aims to solve the abovementioned technical problems.

To solve the abovementioned technical problems, a first objective of the application is to provide a cell-connection aluminum busbar structure integrated with a fuse to fulfill the function of the fuse.

A second objective of the application is to provide a battery pack including a cell-connection aluminum busbar structure integrated with a fuse.

To fulfill the above objectives, the embodiments of the application disclose a cell-connection aluminum busbar structure integrated with a fuse, including a fuse portion 1, a first conductor portion 2 connected to one end of the fuse portion 1, a second conductor portion 3 connected to the other end of the fuse portion 1, a transmission portion 5 connected to a top of the first conductor portion 2, an insulating portion 4 connected to a bottom of the first conductor portion 2, and an aluminum busbar 6 connected to the second conductor portion.

In addition, the cell-connection aluminum busbar structure integrated with a fuse according to the above technical solution of the application may also have the following additional technical features.

Optionally, the transmission portion 5 is one of an electronic wiring harness, a flexible printed circuit and a flexible flat cable.

Optionally, the fuse portion 1 is a ceramic tube fuse or an alloy wire fuse.

Optionally, in a case where the fuse portion 1 is a ceramic tube fuse, an end, connected to the fuse portion 1, of the second conductor portion 3 is configured as a riveted structure, and the other end of the second conductor portion 3 is configured as a flat plane; an end, connected to the fuse portion 1, of the first conductor portion 2 is also configured as a riveted structure.

Optionally, the fuse portion 1 is an etched thin wire.

Optionally, the first conductor portion 2 is a printed circuit, and the second conductor portion 3 is a metal sheet; a bonding pad 8 is arranged on the printed circuit and connects the fuse portion 1 and the transmission portion 5.

Optionally, a tin hole 9 is formed in the metal sheet.

To fulfill the above objectives, in a second aspect, the embodiments of the application provide a battery pack including a cell-connection aluminum busbar structure integrated with a fuse, wherein the battery pack includes the cell-connection aluminum busbar structure integrated with a fuse provided by the embodiments of the application in the first aspect.

The application has the following beneficial effects: 1, the cell-connection aluminum busbar structure has the function of a fuse and is low in manufacturing cost; 2, the structure is designed to be light and thin.

### BRIEF DESCRIPTION OF THE DRAWINGS

FIG. 1 is a structural diagram of a cell-connection aluminum busbar structure integrated with a fuse according to one embodiment of the application;

FIG. 2 is a structural diagram of the cell-connection aluminum busbar structure integrated with a fuse according to another embodiment of the application;

FIG. 3 is a stereogram of the cell-connection aluminum busbar structure integrated with a fuse according to one embodiment of the application;

FIG. 4 is a stereogram of the cell-connection aluminum busbar structure integrated with a fuse according to another embodiment of the application;

FIG. 5 is a partial stereogram of the cell-connection aluminum busbar structure integrated with a fuse according to another embodiment of the application;

### DETAILED DESCRIPTION OF THE EMBODIMENTS

The embodiments of the application are described in detail below, and examples of the embodiments are illustrated in the accompanying drawings, wherein identical or similar reference signs indicate identical or similar elements or components/elements with identical or similar functions. The embodiments described below with reference to the accompanying drawings are illustrative ones used to explain the application and should not be construed as limitations of the application.

A cell-connection aluminum busbar structure integrated with a fuse provided by the embodiments of the application is described below in conjunction with the accompanying drawings.

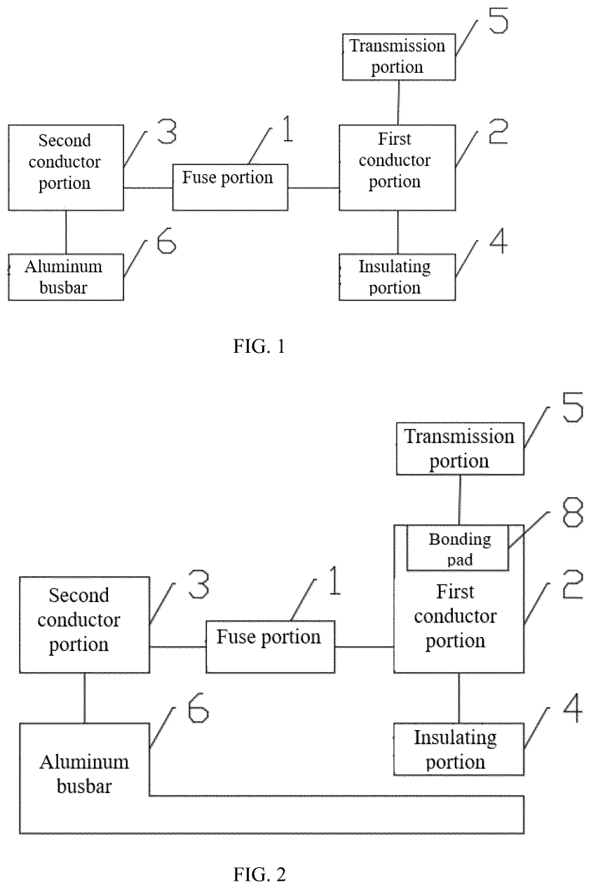

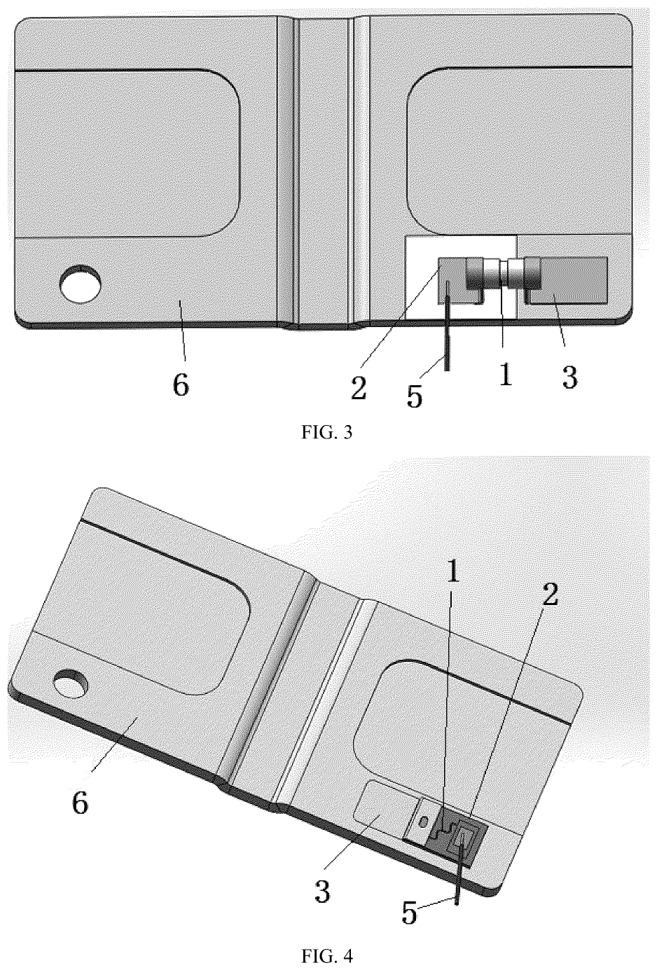

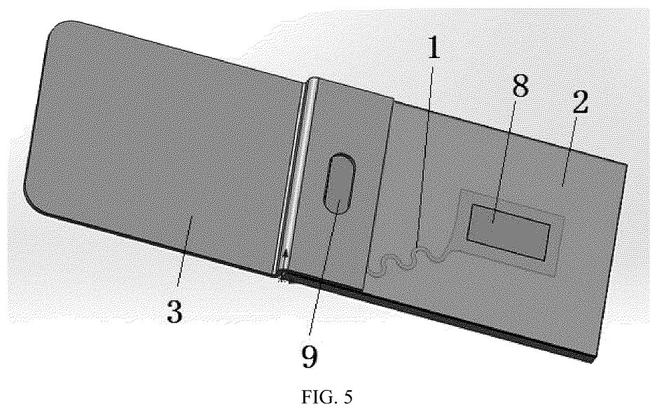

FIG. 1 is a structural diagram of a cell-connection aluminum busbar structure integrated with a fuse according to one embodiment of the application; FIG. 2 is a structural diagram of the cell-connection aluminum busbar structure integrated with a fuse according to another embodiment of the application; FIG. 3 is a stereogram of the cell-connection aluminum busbar structure integrated with a fuse according to one embodiment of the application; FIG. 4 is a stereogram of the cell-connection aluminum busbar structure integrated with a fuse according to another embodiment of the application; FIG. 5 is a partial stereogram of the cell-connection aluminum busbar structure integrated with a fuse according to another embodiment of the application. As shown in FIGS. 1-5, the cell-connection aluminum busbar structure integrated with a fuse includes a fuse portion 1, a first conductor portion 2 connected to one end of the fuse portion 1, a second conductor portion 3 connected to the other end of the fuse portion 1, a transmission portion 5 connected to the top of the first conductor portion 2, an insulating portion 4 connected to the bottom of the first conductor portion 2, and an aluminum busbar 6 connected to the second conductor portion.

According to one embodiment of the application, the fuse portion 1 is a ceramic tube fuse or an alloy wire fuse.

According to one embodiment of the application, in a case where the fuse portion 1 is a ceramic tube fuse, an end, connected to the fuse portion 1, of the second conductor portion 3 is configured as a riveted structure, and the other end of the second conductor portion 3 is configured as a flat plane; an end, connected to the fuse portion 1, of the first conductor portion 2 is also configured as a riveted structure.

### Embodiment 1

First, a special fuse is designed; one end of the fuse is provided with a second conductor portion 3, which is made from metal and welded to an aluminum busbar 6; the other end of the fuse is designed with two layers, an upper layer is provided with a first conductor portion 2 made from metal, and a lower layer is provided with an insulating portion 4 made from an insulating material; a transmission portion 5 such as a wiring harness or an FFC is welded to the metal on the upper layer, and the insulating material on the lower layer is in contact with the aluminum busbar or a CCS. An intermediate region is a fuse region, and a fuse in the fuse region is designed into a traditional ceramic tube or alloy wire.

FIGS. 1 and 3 are a structural diagram and a stereogram of this embodiment. As shown in FIGS. 1 and 3, a ceramic tube is used as the fuse, cylindrical electrically-conductive connecting portions are arranged at two ends of the fuse, and the second conductor portion 3 and the first conductor portion 2 may be fastened and connected by means of riveted structures shown in FIG. 3 to realize electrical connection; an end, connected to the aluminum busbar, of the second conductor portion 3 may be a flat plane to facilitate connection and reduce the thickness of the structure.

According to the cell-connection aluminum busbar structure integrated with a fuse according to the application, an original high-cost design scheme using an FPC may be replaced, and a low-cost wiring harness or FFC is used as a carrier for acquiring and transmitting electric signals, such that the cost is reduced without changing the function; moreover, the structure has a small thickness, which is beneficial to the light and thin design of a battery pack.

According to one embodiment of the application, the transmission portion 5 is one of an electronic wiring harness, a flexible printed circuit and a flexible flat cable.

Specifically, the transmission portion 5 is used for transmitting electric signals and may be a conductor material such as an electronic wiring harness, a flexible printed circuit or a flexible flat cable (FFC) in existing battery packs. Transmission media suitable for mass production or modular production can effectively reduce the overall production cost.

According to one embodiment of the application, the fuse 1 is an etched thin wire.

According to one embodiment of the application, the first conductor portion 2 is a printed circuit, and the second conductor portion 3 is a metal sheet; a bonding pad 8 is arranged on the printed circuit and connects the fuse 1 and the transmission portion 5.

According to one embodiment of the application, a thin hole 9 is formed in the metal sheet.

### Embodiment 2

A fuse portion 1 may use an etched thin wire as a fuse to fulfill the function of the fuse. In this way, the fuse may be manufactured while a printed circuit is produced, thus improving the production efficiency and reducing the cost.

FIGS. 2, 4 and 5 are a schematic diagram and stereograms of this embodiment. As shown in FIGS. 2, 4 and 5, first, a special fuse is designed; one end of the fuse is provided with a metal sheet welded to an aluminum busbar 6; the other end of the fuse is designed with two layers, an upper layer is provided with a circuit board made from metal, and a lower layer is provided with an insulating portion 4 made from an insulating material; a wiring harness or an FFC is welded to the metal on the upper layer, and the insulting layer on the lower layer is in contact with the aluminum busbar. An intermediate S-region is a fuse region formed by etching or die-cutting an FPC. Such a design is light and thin and saves space.

A bonding pad 8 is used for welding a wire to the printed circuit. A special welding region is designed to perform laser welding, tin soldering, or superconducting wave welding. To prevent the bonding pad from falling due to vibrations or an external force, an adhesive may be smeared to form a protection layer to ensure the connection stability and reliability.

A tin hole 9 is formed in the metal sheet to allow soldering tin to infiltrate into the metal sheet easily when the metal sheet is welded to the aluminum busbar, thus ensuring welding reliability; moreover, gas produced in the welding process may be discharged via the tin hole, thus ensuring welding and connection reliability.

Based on the above embodiments, the embodiments of the invention further provide a battery pack, including the cell-connection aluminum busbar structure integrated with a fuse in the above embodiments.

According to the cell-connection aluminum busbar structure integrated with a fuse, and the battery pack provided by the application, an original high-cost design scheme using an FPG may be replaced, and a low-cost wiring harness or FFC is used as a carrier for acquiring and transmitting electric signals, such that the cost is reduced without changing the function.

The above embodiments are preferred ones of the application, and in addition to the above embodiments, the application may also be implemented in other ways. Any obvious substitutions made without departing from the concept of the application should also fall within the protection scope of the application.

What is claimed is:

1. A cell-connection aluminum busbar structure integrated with a fuse, comprising a fuse portion (1), a first conductor portion (2) connected to one end of the fuse portion (1), a second conductor portion (3) connected to the other end of the fuse portion (1), a transmission portion (5) connected to a top of the first conductor portion (2), an insulating portion (4) connected to a bottom of the first conductor portion (2), and an aluminum busbar (6) connected to the second conductor portion.

2. The cell-connection aluminum busbar structure integrated with a fuse according to claim 1, wherein the transmission portion (5) is one of an electronic wiring harness, a flexible printed circuit and a flexible flat cable.

3. The cell-connection aluminum busbar structure integrated with a fuse according to claim 1, wherein the fuse portion (1) is a ceramic tube fuse or an alloy wire fuse.

4. The cell-connection aluminum busbar structure integrated with a fuse according to claim 3, wherein in a case where the fuse portion (1) is a ceramic tube fuse, one end, connected to the fuse portion (1), of the second conductor portion (3) is configured as a riveted structure, and the other end of the second conductor portion (3) is configured as a flat plane; an end, connected to the fuse portion (1), of the first conductor portion (2) is also configured as a riveted structure.

5. The cell-connection aluminum busbar structure integrated with a fuse according to claim 1, wherein the fuse portion (1) is an etched thin wire.

6. The cell-connection aluminum busbar structure integrated with a fuse according to claim 5, wherein the first conductor portion (2) is a printed circuit, and the second conductor portion (3) is a metal sheet; a bonding pad (8) is arranged on the printed circuit and connects the fuse portion (1) and the transmission portion (5).

7. The cell-connection aluminum busbar structure integrated with a fuse according to claim 6, wherein a tin hole (9) is formed in the metal sheet.

8. A battery pack, comprising the cell-connection aluminum busbar structure integrated with a fuse according to claim 1.
